(19) United States
(12) Patent Application Publication
(10) Pub. No.: US 2016/0362029 A1
(43) Pub. Date: Dec. 15, 2016

(54) DRAWER DEVICE

(71) Applicant: TOYODA GOSEI CO., LTD., Kiyosu-shi (JP)

(72) Inventors: Yoshinori MASATSUGU, Kiyosu-shi (JP); Nobuhiko YOKOTA, Kiyosu-shi (JP); Kenji ASANO, Nagoya-shi (JP)

(21) Appl. No.: 15/140,840

(22) Filed: Apr. 28, 2016

(30) Foreign Application Priority Data
Jun. 9, 2015 (JP) 2015-116602

(51) Int. Cl. B60N 3/10

(52) U.S. Cl. CPC B60N 3/102; B60N 3/106

(57) ABSTRACT

A cup holder device of the present invention includes an advancing and retracting mechanism configured to move a drawer member between an advance position to which the drawer member is advanced from an opening, and a retraction position to which the drawer member is retracted into the opening. The advancing and retracting mechanism includes: a movable portion provided in a storage case and configured to be movable in an advancing and retracting direction; a drawing linkage portion configured to move the drawer member in the advancing and retracting direction according to movement of the movable portion in the advancing and retracting direction, and to displace the drawer member so as to orient the drawer member almost perpendicular to the advancing and retracting direction, by causing the drawer member and the movable portion to cooperate with each other; and an orientation changing portion configured to regulate the drawer member so as to be in a first orientation in which the drawer member can be stored in the storage case when the drawer member is at the retraction position, and to displace the drawer member from the first orientation to a second orientation when the drawer member is drawn to the advance position according advancing of the movable portion.

### TECHNICAL FIELD

The present invention relates to a drawer device having a drawer member that is stored in a storage case and is drawn when used.

### BACKGROUND ART

In vehicle interiors, cup holder devices are provided. Some of the cup holder devices are drawer-type cup holder devices which are stored in storage cases and have holder portions that are drawn when used. The drawer-type cup holder device is disclosed in, for example, Japanese Laid-Open Patent Publication No. H07-291013.

The cup holder device disclosed in Japanese Laid-Open Patent Publication No. H07-291013 includes: a storage case 91 having an opening 90; and a drawer-type holder body 92 that is stored in the storage case 91 so as to be advanced therefrom and retracted thereinto, as shown in FIG. 17 and FIG. 18. The holder body 92 has a rotatable gear 93, and the gear 93 meshes with a rack 94 that extends along directions in which the holder body 92 is advanced and retracted. Below the holder body 92, a bottom member 95 for holding the bottom portion of a beverage container C is provided. The bottom member 95 and the holder body 92 are connected by an arm 96 that can swing relative to the bottom member 95 and the holder body 92. When the holder body 92 is retracted into the opening 90, the bottom member 95 is moved close to the holder body 92 by swinging of the arm 96, and both the bottom member 95 and the holder body 92 are stored into the opening 90.

### SUMMARY OF INVENTION

### Technical Problem

A cup holder device is required in which the holder body 92 is tilted so as to orient the advance side front end portion of the holder body 92 upward and the height of the holder body 92 from the bottom member 95 is increased such that the beverage container C is stably held.

However, in the drawer device disclosed in Japanese Laid-Open Patent Publication No. H07-291013, the storage case 91 needs to have the opening 90 corresponding to the height of the tilted holder body 92 in order to advance the holder body 92 from the storage case 91 and retract the holder body 92 thereinto. Therefore, the thickness of the storage case 91 is increased, and the reduction in size of the entirety of the cup holder device is restricted.

Further, Japanese Laid-Open Patent Publication No. 2012-11821 and Japanese Laid-Open Utility Model Publication No. H05-86699 also disclose drawer-type cup holder devices similar to that disclosed in Japanese Laid-Open Patent Publication No. H07-291013, and these cup holder devices have the same problem as that disclosed in Japanese Laid-Open Patent Publication No. H07-291013.

In addition to the cup holder devices, in some cases, when a table that can be stored in a storage case is drawn, the table is required to be oriented such that the table is tilted relative to directions in which the table is advanced and retracted. Reduction in thickness of the storage case for such a drawable table is also restricted.

The present invention is made in view of these circumstances, and an object of the present invention is to provide a drawer device that can displace a drawer member so as to tilt the drawer member relative to the advancing and retracting direction when the drawer member is drawn, and that also has a reduced thickness.

### Solution to Problem

A drawer device of the present invention includes:

a storage case having an opening;

a drawer member stored in the storage case so as to be advanced from the opening toward an advance side or retracted into the opening toward a retraction side; and

an advancing and retracting mechanism configured to move the drawer member between an advance position to which the drawer member is advanced from the opening, and a retraction position to which the drawer member is retracted into the opening, in the drawer device,

the advancing and retracting mechanism includes:
a movable portion provided in the storage case and configured to be movable in an advancing and retracting direction;
a drawing linkage portion configured to move the drawer member in the advancing and retracting direction according to movement of the movable portion in the advancing and retracting direction, and to displace the drawer member so as to orient the drawer member almost perpendicular to the advancing and retracting direction, by causing the drawer member and the movable portion to cooperate with each other; and
an orientation changing portion configured to regulate the drawer member so as to be in a first orientation in which the drawer member can be stored in the storage case when the drawer member is at the retraction position, and to displace the drawer member from the first orientation to a second orientation when the drawer member is drawn to the advance position according advancing of the movable portion.

### ADVANTAGEOUS EFFECTS OF INVENTION

In the above-described configuration, the drawer member is advanced from or retracted into the opening of the storage case according to movement of the movable portion in the advancing and retracting direction. When the drawer member is retracted to the retraction position in the opening of the storage case, the orientation of the drawer member is regulated by the orientation changing portion so as to be a predetermined orientation in which the drawer member can be stored in the opening of the storage case. When the drawer member is drawn to the advance position by advancing of the movable portion, the orientation of the drawer member is changed from the first orientation to the second orientation by the orientation changing portion. For example, the orientation of the drawer member is regulated such that the drawer member at the retraction position has a height less than the width of the opening, whereby the drawer member can be stored even in a thin storage case. Therefore, the drawer member can be displaced so as to be tiled relative to the advancing and retracting direction when the drawer member is drawn, and reduction in thickness of the drawer device can be also achieved.

In a case where the drawer member and the movable portion are connected such that the drawer member and the movable portion cannot be displaced relative to each other, when the orientation of the drawer member at the advance positon changes to the orientation of the drawer member at the retraction position, the drawer member may interfere with the movable portion that is movable in the advancing and retracting direction.

In the present invention, the drawing linkage portion causes the drawer member and the movable portion to cooperate with each other such that the drawer member is displaced so as to be oriented almost perpendicular to the advancing and retracting direction. The drawing linkage portion allows the drawer member to be moved in the advancing and retracting direction according to movement of the movable portion in the advancing and retracting direction, and allows a relative position of the drawer member relative to the movable portion to be changed according to the orientation of the drawer member being changed. Therefore, the orientation of the drawer member can be smoothly changed according to movement in the advancing and retracting direction without interference with the movable portion.

As described above, according to the present invention, the drawer device can be provided in which the drawer member can be displaced so as to be tilted relative to the advancing and retracting direction when the drawer member is drawn, and reduction in thickness can be also achieved.

### BRIEF DESCRIPTION OF DRAWINGS

FIG. 1 is a perspective view of a drawer device in which a drawer member is at an advance position, according to a first embodiment of the present invention;

FIG. 2 is a perspective view of the drawer device in which the drawer member is at a retraction position in the first embodiment;

FIG. 3 is an exploded perspective view of the drawer device in the first embodiment;

FIG. 4 is a perspective view of a lower member and a movable portion of a storage case in the first embodiment;

FIG. 5 is a perspective view of the lower member, the movable portion, and the drawer member of the storage case in the first embodiment;

FIG. 6 is a cross-sectional view of the lower member of the storage case in which the movable portion is disposed, as taken along a plane in the front-rear and the left-right direction in the first embodiment;

FIG. 7 is a sectional view, as seen from the direction of arrows A-A in FIG. 6, of the drawer member and the movable portion which are disposed in the lower member of the storage case;

FIG. 8 is a cross-sectional view of the drawer member disposed at the retraction position, as taken along a plane in the front-rear and left-right direction of the drawer device, in the first embodiment;

FIG. 9 is a sectional view as seen from the direction of arrows H-H in FIG. 1;

FIG. 10 is a sectional view as seen from the direction of arrows E-E in FIGS. 2 and 8;

FIG. 11 is a sectional view, as seen from the direction of arrows I-I in FIG. 1, of a trajectory obtained when the drawer member is moved from the advance position to the retraction position;

FIG. 12 is a sectional view as seen from the direction of the arrows I-I in FIG. 1;

FIG. 13 is a cross-sectional view of the drawer device in the case of an operation portion being operated when the drawer member is at the retraction position, as taken along a plane of the drawer device in the front-rear and left-right direction, in the first embodiment;

FIG. 14 is a perspective view of a table device in which a table is at an advance position according to a second embodiment;

FIG. 15 is a sectional view as seen from the direction of arrows J-J in FIG. 14;

FIG. 16 is a sectional view, as seen from the direction of the arrows J-J in FIG. 14, illustrating a direction in which a rail portion extends;

FIG. 17 is a perspective view of a conventional cup holder device; and

FIG. 18 is a perspective view of the conventional cup holder device as seen from the back surface side of a holder body.

### DESCRIPTION OF EMBODIMENTS

### First Embodiment

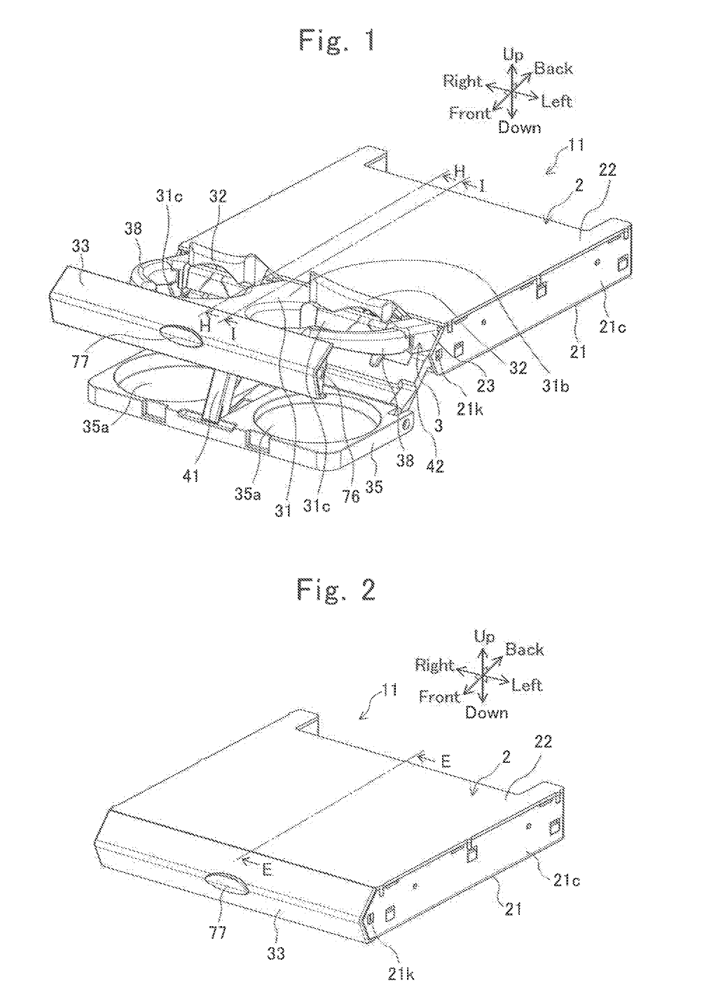

A drawer device according to a first embodiment of the present invention will be described in detail with reference to the drawings . The drawer device of the present embodiment is a drawer-type cup holder device, and is provided in a rear console at the center of a rear seat in a vehicle interior . In FIG. 1 and the other drawings, the upper, lower, left, right, front, and rear directions are directions as seen from a person in the vehicle.

As shown in FIG. 1 to FIG. 3, a cup holder device 11 includes a storage case 2, a drawer member 3, and an advancing and retracting mechanism 7. The drawer member 3 is moved, by the advancing and retracting mechanism 7, between: an advance position (FIG. 1) to which the drawer member 3 is advanced from the storage case 2; and a retraction position (FIG. 2) to which the drawer member 3 is retracted into the storage case 2.

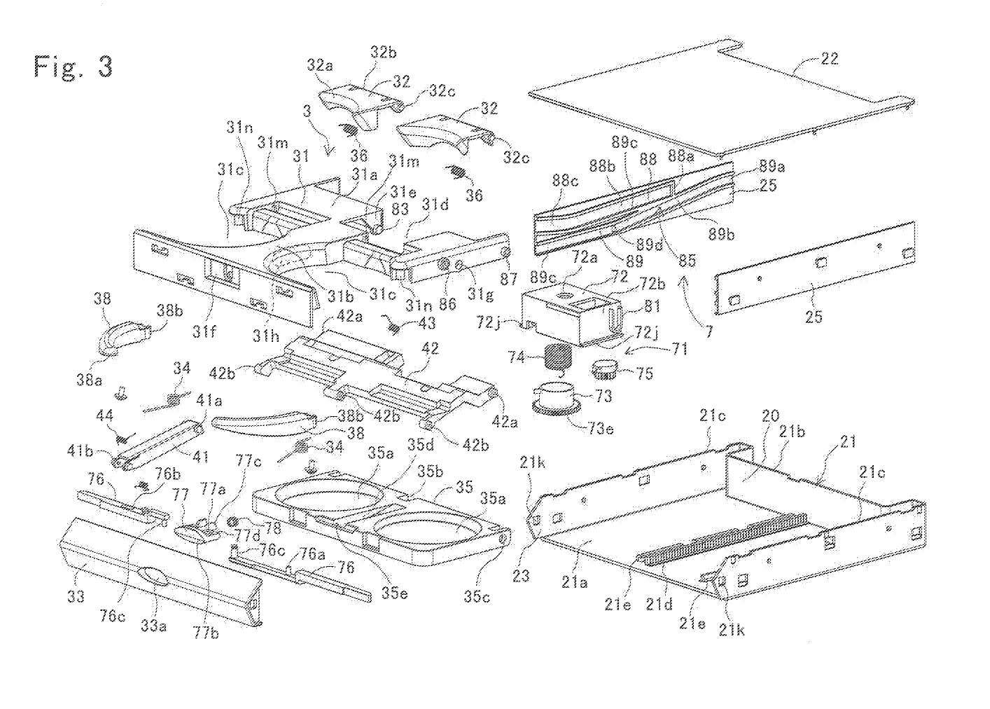

As shown in FIG. 3, the storage case 2 is a rectangular thin case, and includes a lower member 21 and an upper member 22. The lower member 21 has a rectangular bottom wall 21a, and a rear wall 21b and side walls 21c that stand on the rear side and both the left and right sides of the bottom wall 21a. The upper member 22 has a rectangular shape corresponding to the shape of the bottom wall 21a of the lower member 21. The perimeter portion of the upper member 22 is projection-recess fitted into the upper perimeter portion of the rear wall 21b of the lower member 21 and the upper perimeter portions of the side walls 21c thereof, whereby the upper member 22 and the lower member 21 are integrated with each other . The storage case 2 includes a space 20 surrounded by the upper member 22 and the lower member 21. The space 20 has such a size as to store the drawer member 3, and is in communication with the outside through an opening 23 formed at the front side of the storage case 2.

As shown in FIG. 1 and FIG. 3, the drawer member 3 has: a holder body 31 that can hold the side surface of a beverage container; a bottom member 35 that can hold the bottom portion of the beverage container; a rear member 42, and a front member 41.

The holder body 31 has a base portion 31a provided on the rear side, and a holder portion 31b that projects toward the front side from the center, in the left-right direction, of the base portion 31a. The holder portion 31b projects toward the front side from the center portion, in the left-right direction, of the base portion 31a. An insertion space 31c is provided on each of the left and right sides of the holder portion 31b, and the beverage container is inserted in the insertion space 31c. The holder portion 31b holds the beverage container at the side surface portion opposing the insertion space 31c. On the front side of the base portion 31a, a pair of first swing holding portions 32 are provided on both the left and right sides so as to dispose the holder portion 31b between the paired first swing holder portions 32. Engagement projections 32c formed on the base end of the first swing holding portions 32 are inserted into holes 31m of the holder body 31. Springs 36 are disposed between the engagement projections 32c and the circumferential portions of the holes 31m. Thus, the first swing holding portion 32 can swing upward relative to the base portion 31a, and is urged upward. The first swing holding portion 32 is urged by the spring 36 such that a front end portion 32a is positioned upward of a rear end portion 32b. When the holder body 31 is at the retraction position, the front end portion 32a of the first swing holding portion 32 is pressed downward by the upper member 22 of the storage case 2, and is at almost the same height as the rear end portion 32b of the first swing holding portion 32.

Further, claw-shaped second swing holding portions 38 are provided on both the left and right sides, respectively, of the front end portion of the base portion 31a. Holes formed in base ends 38b of the second swing holding portions 38 are fitted to rotation shafts 31n of the holder body 31 from the outside thereof . Springs 34 are disposed between circumferential portions of the holes of the base ends 38b and the rotation shafts 31n. Thus, a front end 38a of each second swing holding portion 38 can swing in the inner and outer direction of the insertion space 31c, and is urged toward the vicinity of the center . When a beverage container is inserted in the insertion space 31c, the side surface of the beverage container is held by the holder body 31, the first swing holding portion 32, and the second swing holding portion 38.

Below the holder body 31, the bottom member 35 is disposed. The bottom member 35 has a pair of recessed bottom holding portions 35a on both the left and right sides. The insertion space 31c is disposed immediately above each bottom holding portion 35a. When the beverage container is inserted in the insertion space 31c of the holder body 31, the bottom portion of the beverage container is held by the bottom member 35.

The holder body 31 and the bottom member 35 are connected with each other by the front member 41 and the rear member 42. A four element linking mechanism as described below allows the front member 41 and the rear member 42 to swing relative to the holder body 31 and the bottom member 35.

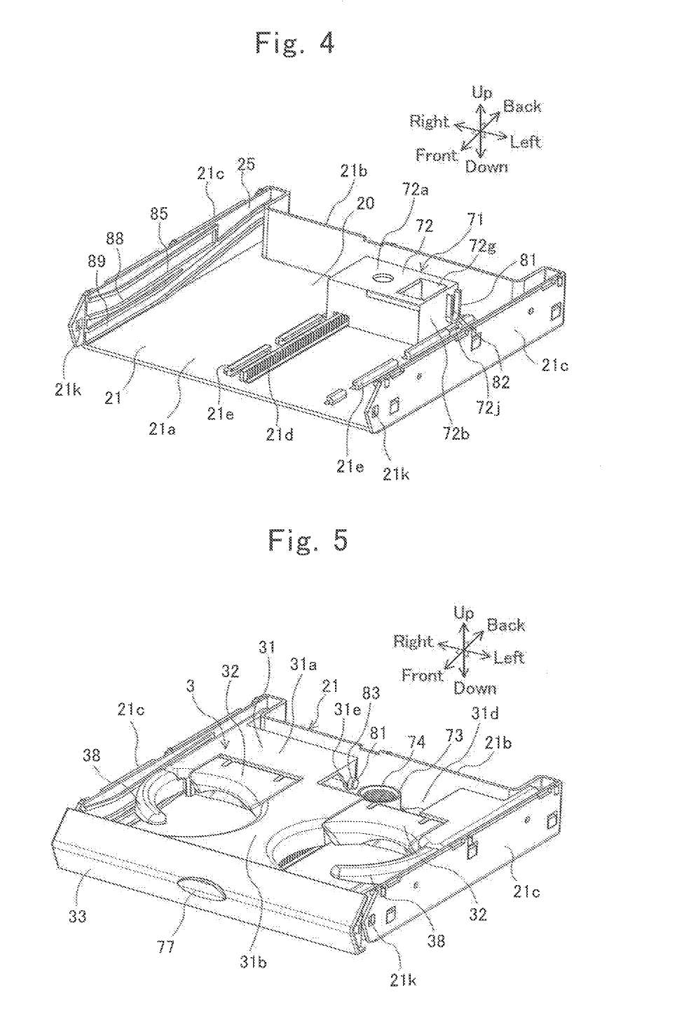

As shown in FIG. 3 and FIG. 4, the advancing and retracting mechanism 7 allows the drawer member 3 to advance from the opening 23 of the storage case 2 or retract into the opening 23 thereof. The advancing and retracting mechanism 7 includes a movable portion 71, a drawing linkage portion 81, and an orientation changing portion 85.

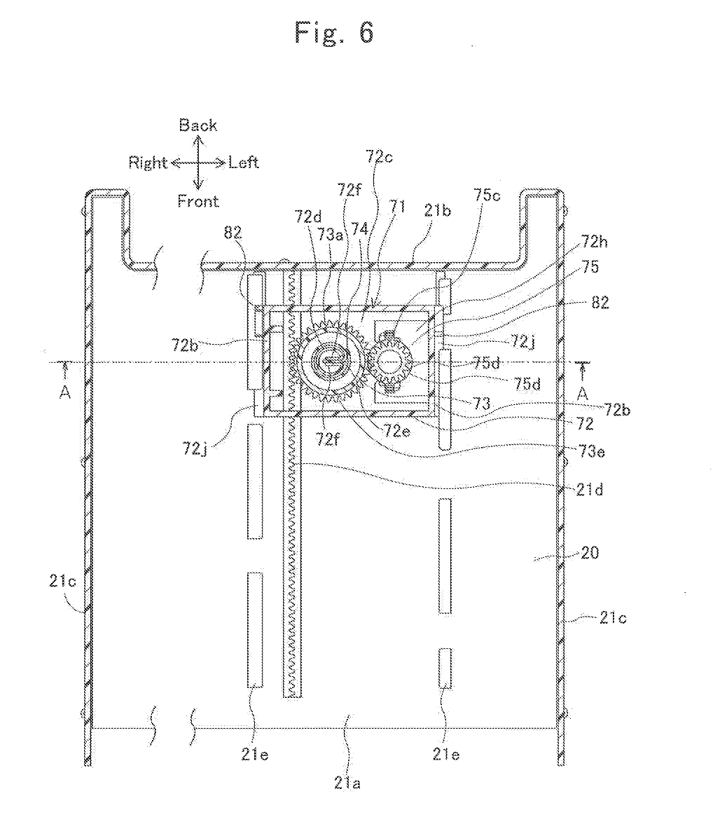

As shown in FIG. 4, FIG. 5, and FIG. 6, the movable portion 71 includes a gear box 72, a rotary member 73, an urging member 74, and a damper device 75.

The gearbox 72 has an upper wall 72a, side walls 72b connected to the circumferential edge of the upper wall 72a, and a gear space 72c surrounded by the upper wall 72a and the side walls 72b. The rotary member 73 and the urging member 74 are disposed on the right side of the gear space 72c of the gear box 72, and the damper device 75 is disposed on the left side of the gear space 72c.

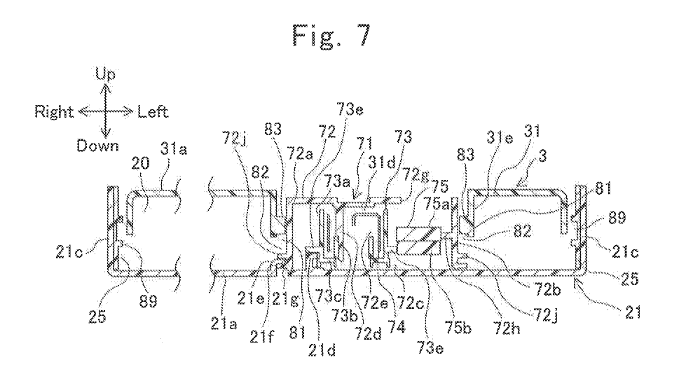

As shown in FIG. 6 and FIG. 7, the rotary member 73 includes an outer cylindrical portion 73a, an inner cylindrical portion 73b, and a bottom surface portion 73c that connects between the outer cylindrical portion 73a and the inner cylindrical portion 73b. The gear box 72 has a holding cylindrical portion 72d that projects downward from the upper wall 72a toward the gear space 72c. The holding cylindrical portion 72d is a cylindrical body having an almost C-shaped cross-section, and having a slit 72e formed in a part of the side portion. The holding cylindrical portion 72d holds the inner cylindrical portion 73b of the rotary member 73 such that the inner cylindrical portion 73b is rotatable.

A flange portion is provided on the lower side of the outer cylindrical portion 73a so as to project radially outward, and the flange portion has a pinion gear 73e formed over the entirety of the circumference. The lower end of the outer cylindrical portion 73a and the lower end of the inner cylindrical portion 73b are connected by the bottom surface portion 73c. A spring chamber having a width corresponding to the width of the bottom surface portion 73c is formed between the outer cylindrical portion 73a and the inner cylindrical portion 73b, and the urging member 74 is disposed in the spring chamber . The urging member 74 is implemented as a coil spring. One end portion of the urging member 74 is held at the lower end portion of the outer cylindrical portion 73a of the rotary member 73. The other endportion of the urging member 74 extends radially inward from the slit 72e of the holding cylindrical portion 72d of the gear box 72, and is held between a pair of fixing walls 72f that project downward from the upper wall 72a of the gear box 72.

When the rotary member 73 is rotated relative to the gear box 72 in one direction, urging force is accumulated in the urging member 74. When the accumulated urging force is released, the urging member 74 allows the rotary member 73 to rotate relative to the gear box 72 in the direction opposite to the one direction.

As shown in FIG. 4, FIG. 6, and FIG. 7, the damper device 75 is disposed on the left side of the gear space 72c of the gear box 72, and has a fixed member 75a and a rotary member 75b. The fixed member 75a has a pair of fitting portions 75c that project forward and rearward. An opening 72g is formed on the left side of the upper wall 72a of the gear box 72. The damper device 75 is inserted into the gear space 72c through the opening 72g. The pair of fitting portions 75c is projection-recess fitted into a holding plate portion 72h disposed on the left side of the gear space 72c of the gear box 72, whereby the fixed member 75a is fixed to the gearbox 72. Not-illustrated viscous liquid is enclosed in the damper device 75, and the fixed member 75a and the rotary member 75b are indirectly connected to each other by the viscous liquid. The viscous liquid inhibits increase of a rotation speed of the rotary member 75b due to the viscosity thereof. The rotary member 75b has a damper gear 75d. The damper gear 75d meshes with the pinion gear 73e. Therefore, the damper device 75 reduces increase of a rotation speed of the pinion gear 73e.

A rack gear 21d is disposed at the center portion, in the left-right direction, of the bottom wall 21a of the lower member 21. The rack gear 21d extends in the front-rear direction, that is, along the directions in which the drawer member 3 is advanced and retracted.

The pinion gear 73e of the rotary member 73 meshes with the rack gear 21d. When the rotary member 73 is rotated relative to the gear box 72 in one direction, urging force is accumulated in the urging member 74, and the gear box 72 is moved rearward along the rack gear 21d. When the urging force of the urging member 74 is released, the rotary member 73 is rotated in the direction opposite to the one direction, and the gear box 72 is moved forward along the rack gear 21d.

In the movable portion 71, the pinion gear 73e is urged by the urging force of the urging member 74. The urged pinion gear 73e is advanced along the rack gear 21d provided in the storage case 2. In such a simple structure, the movable portion 71 can be assuredly advanced.

As shown in FIG. 7, slide portions 72j are provided at the lower portions of the side walls 72b on both the left and right sides of the gear box 72 so as to project outward in the left-right direction. Further, paired box guide portions 21e are provided on the bottom wall 21a of the lower member 21 of the storage case 2 so as to extend parallel to each other in the advancing and retracting direction. The paired box guide portions 21e each has: a stand wall 21f that extends upward from the bottom wall 21a of the storage case 2; and a bent wall 21g that is bent at the upper portion of the stand wall 21f in the left-right direction. Each slide portion 72j of the gear box 72 is surrounded by the stand wall 21f, the bent wall 21g, and the bottom wall 21a of the storage case 2, to inhibit movement of the slide portion 72j in the up-down direction and the left-right direction. Therefore, the slide portion 72j can be moved relative to the storage case 2 only in the advancing and retracting direction.

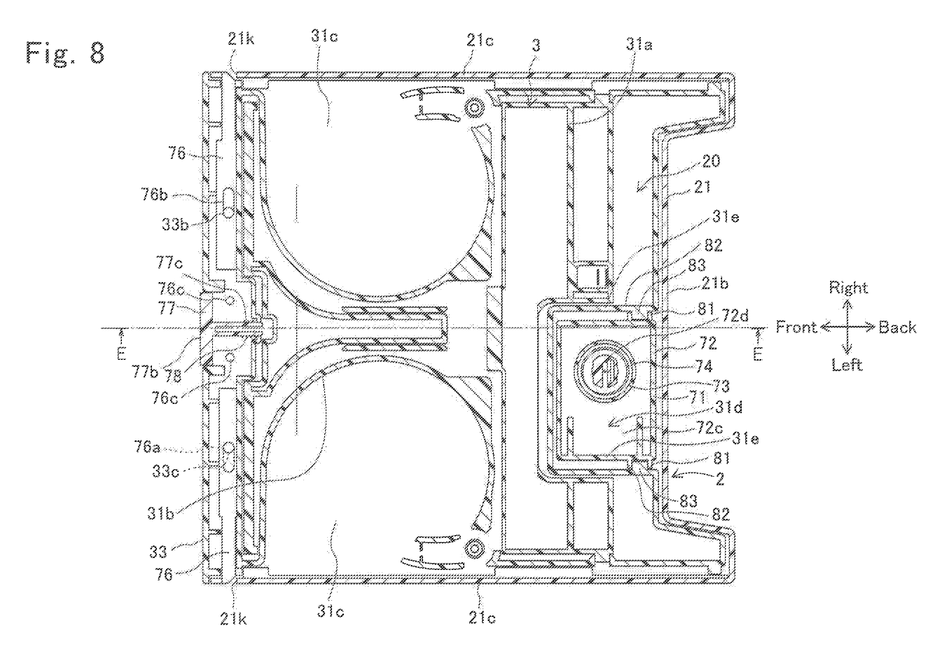

As shown in FIG. 4, FIG. 5, and FIG. 8, the drawing linkage portion 81 is provided between the movable portion 71 and the drawer member 3. The drawing linkage portion 81 includes: guide portions 82 disposed on the side walls 72b on both the left and right sides of the gearbox 72 of the movable portion 71; and engagement portions 83 provided in the holder body 31 of the drawer member 3. Each guide portion 82 is a U-shaped groove that is provided on the side wall 72b of the gear box 72 and that extends in the up-down direction. The lower portion of the guide portion 82 is closed, and the upper portion of the guide portion 82 is open.

As shown in FIG. 3, a portion, immediately above the gear box 72, of the base portion 31a of the holder body 31 is hollowed to form a rear space 31d. Opposing walls 31e are provided on both the right and left sides of the rear space 31d. On the opposing walls 31e, a pair of the engagement portions 83 are provided so as to project toward the rear space 31d. The paired engagement portions 83 oppose each other and are on the same axial line. In the rear space 31d, the movable portion 71 is disposed, and the engagement portions 83 provided in the holder body 31 engage with the guide portions 82 provided in the movable portion 71 so as to be movable relative thereto in the up-down direction. Therefore, the holder body 31 is linked to the movable portion 71 so as to be displaced relative thereto in the up-down direction, and further the holder body 31 is also moved in the advancing and retracting direction according to movement of the movable portion 71 in the advancing and retracting direction.

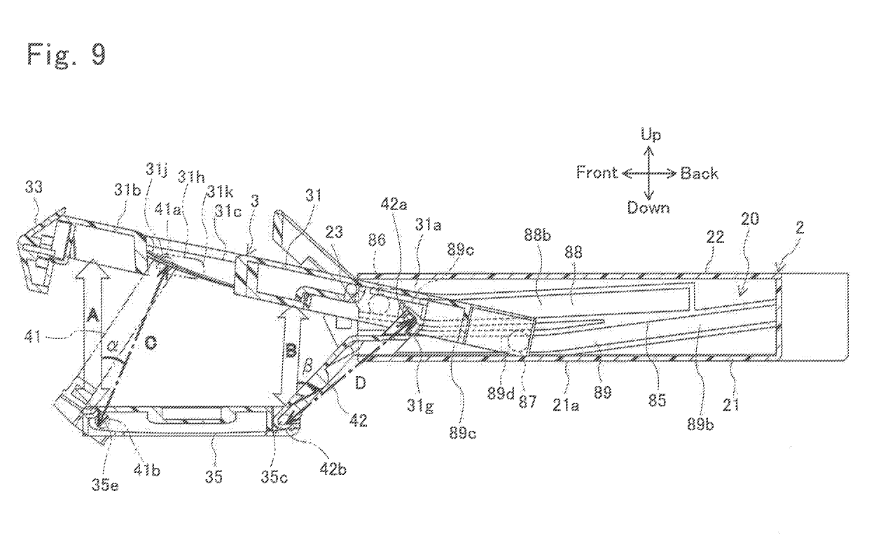

As shown in FIG. 3, FIG. 4, and FIG. 9, the orientation changing portion 85 is provided in the storage case 2 and the holder body 31 of the drawer member 3 . The orientation changingportion 85 changes the orientation of the holder body 31 relative to the storage case 2 according to movement of the holder body 31 in the advancing and retracting direction. The orientation changing portion 85 includes a front side slide engagement portion 86 and a rear side slide engagement portion 87 provided in the holder body 31, and an upper rail portion 88 and a lower rail portion 89 provided in the storage case 2.

The front side slide engagement portion 86, and the rear side slide engagement portion 87 that is disposed rearward of the front side slide engagement portion 86 are provided so as to project on each of the side walls on both the right and left sides of the base portion 31a of the holder body 31. The front side slide engagement portion 86 is disposed slightly upward of the rear side slide engagement portion 87. The front side slide engagement portion 86 and the rear side slide engagement portion 87 are slidably supported by the upper rail portion 88 and the lower rail portion 89.

The upper rail portion 88 and the lower rail portion 89 are provided on an inner wall member 25 fixed to each side wall 21c of the storage case 2. The orientation changing portion 85 guides the holder body 31 such that, when the holder body 31 is at the retraction position, the orientation of the holder body 31 is regulated so as to be a predetermined orientation in which the holder body 31 can be stored in the storage case 2, and, when the holder body 31 is drawn from the retraction position toward the advance position, the orientation of the holder body 31 is changed from the predetermined orientation at the retraction position.

The upper rail portion 88 is provided on the upper side of the inner wall member 25, and the lower rail portion 89 is provided downward of the upper rail portion 88 on the inner wall member 25. The upper rail portion 88 and the lower rail portion 89 may be implemented as, for example, grooves, long holes, or rails that extend almost in the advancing and retracting direction. In the present embodiment, grooves are used.

The lower rail portion 89 extends from the rear end to the front end over the inner wall member 25 almost in the advancing and retracting direction. The lower rail portion 89 has: a tilted portion 89b that extends gradually downward from the rear end toward the front portion; and a front-rear extension portion 89c that extends toward the front side, in almost the center portion in the advancing and retracting direction, along the lower perimeter edge of the inner wall member 25. In the upper rail portion 88, a rearmost end portion 88a is disposed forward of a rearmost end 89a of the lower rail portion 89. The upper rail portion 88 has : a first tilted portion 88b that extends gradually downward from the rearmost end portion 88a toward the front side; and a second tilted portion 88c that is tilted upward near the opening. The upper rail portion 88 has such a shape as to extend downward and then extend upward again such that the first swing holding portion 32 provided in the holder body 31 is inhibited from interfering with the upper member 22 of the storage case 2 during retraction. A distance between the upper rail portion 88 and the lower rail portion 89 is gradually increased from the rear side toward the front side.

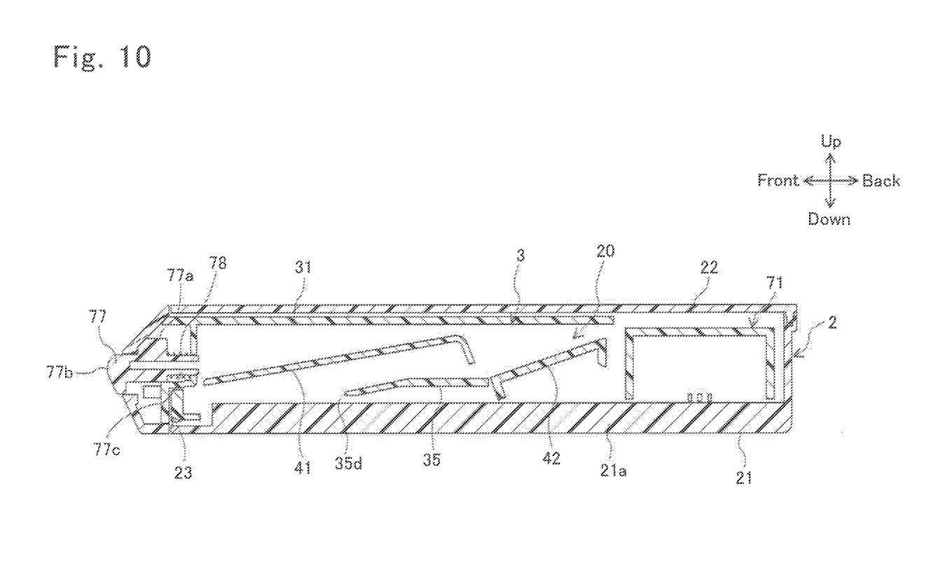

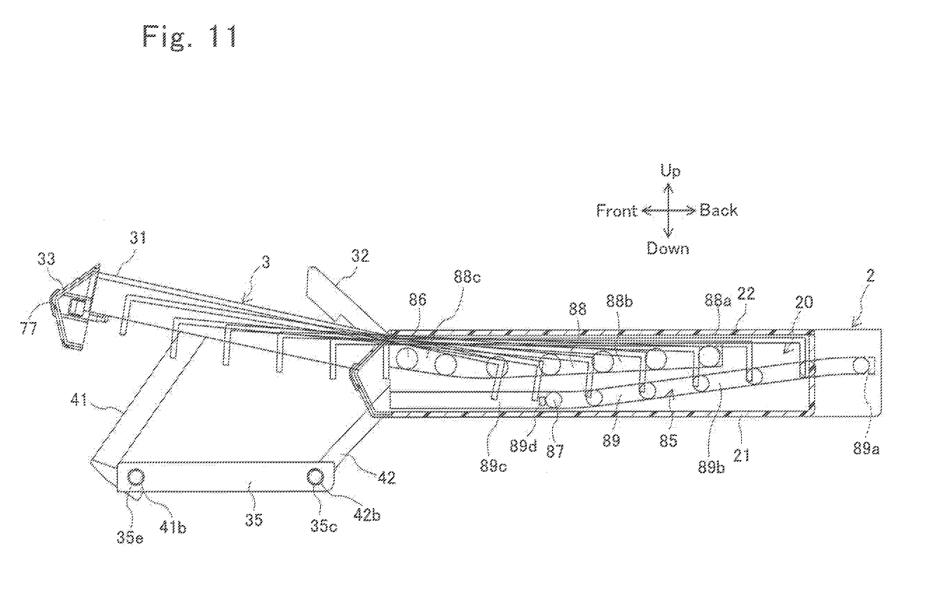

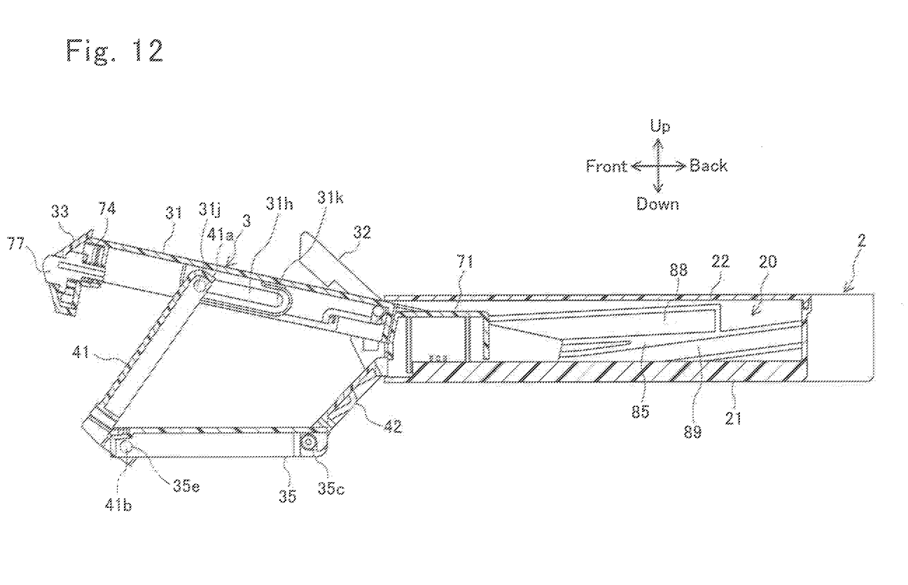

As shown in FIG. 10 and FIG. 11, the front side slide engagement portion 86 and the rear side slide engagement portion 87 are supported by the upper rail portion 88 and the lower rail portion 89, whereby the orientation of the holder body 31 is regulated so as to be a predetermined orientation in which the holder body 31 can be retracted into the opening 23 of the storage case 2 when the holder body 31 is at the retraction position. As shown in FIG. 11, while the holder body 31 slides from the retraction position toward the advance position, the rear side slide engagement portion 87 is lowered downward of the front side slide engagement portion 86, and the front side portion of the holder body 31 is positioned so as to be higher than the rear side portion thereof. As shown in FIG. 11 and FIG. 12, near the advance position, a difference in height between the front side slide engagement portion 86 and the rear side slide engagement portion 87 is increased, and the front portion of the holder body 31 is positioned so as to be higher than the rear portion thereof. The rear side slide engagement portion 87 is stopped by a stopper 89d provided in the front-rear extension portion 89c of the lower rail portion 89, and the drawer member 3 stops at the advance position. Thus, while the holder body 31 is moved from the retraction position toward the advance position, the orientation of the holder body 31 is changed from the predetermined orientation of the holder body 31 positioned at the retraction position.

Further, as shown in FIG. 3, FIG. 8, and FIG. 10, the advancing and retracting mechanism 7 includes : a lock portion 76 for preventing the drawer member 3 from moving at the retraction position; an operation portion 77 for cancelling prevention of movement of the drawer member 3 by the lock portion 76; and a lock urging member 78. The lock portion 76 and the operation portion 77 are provided at the front portion of the holder portion 31b of the holder body 31 . The front portion of the holder portion 31b has the width extended in the left-right direction, and is covered with a design cover 33. The operation portion 77 and the lock portion 76 are provided between the front portion of the holder portion 31b, and the design cover 33.

As shown in FIG. 3, the operation portion 77 is held in operation holding holes 33a and 31f formed at the center, in the left-right direction, of the design cover 33 and the front portion of the holder portion 31b, so as to be movable in the advancing and retracting direction.

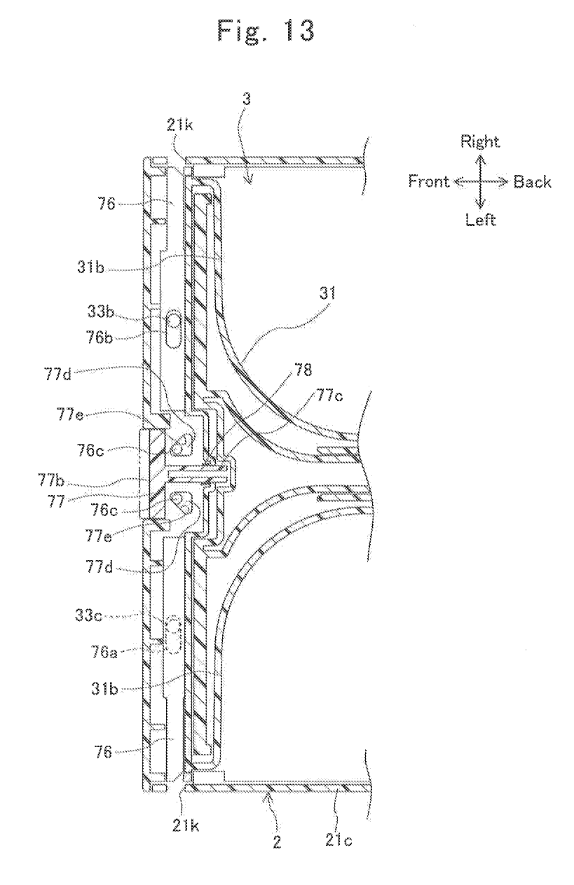

As shown in FIG. 8 and FIG. 13, the rod-shaped lock portions 76 are disposed on both the left and right sides lateral to the operation portion 77. The lock portion 76 on the left side has a guide pin 76a, and the lock portion 76 on the right side has a long hole 76b that extends in the left-right direction. The guide pin 76a is inserted into a long hole 33c that extends in the left-right direction and that is formed on the rear surface side of the design cover 33. Into the long hole 76b, a guide pin 33b provided on the rear surface side of the design cover 33 is inserted. Thus, a pair of the left and right lock portions 76 are movable in the left-right direction.

The outer ends, in the left-right direction, of the lock portions 76 are inserted into lock engagement holes 21k formed in the side walls 21c of the lower member 21 of the storage case 2 so as to be advanced and retracted. When the drawer member 3 is at the retraction position and the lock portions 76 are inserted in the lock engagement holes 21k, the drawer member 3 is prevented from moving at the retraction position.

As shown in FIG. 3 and FIG. 13, the operation portion 77 has: a base portion 77a; an operation surface 77b provided on the front side of the base portion 77a; a spring holding portion 77c provided on the rear side of the base portion 77a; and a pair of left and right guide holes 77d provided in the base portion 77a. The lock urging member 78 is a compression coil spring, and is held by the spring holding portion 77c. The lock urging member 78 is provided between the spring holding portion 77c of the operation portion 77, and the front portion of the holder portion 31b, and urges the operation portion 77 forward with respect to the holder portion 31b. The paired left and right guide holes 77d have slanted portions 77e that are slanted in the left-right outward direction toward the rear side. Into each guide hole 77d, a projection 76c formed in the lock portion 76 is inserted.

By the operation surface 77b being pressed rearward, the operation portion 77 is retracted against urging force of the lock urging member 78. The projections 76c are moved relative to the guide holes 77d toward the front sides of the guide holes 77d along the slanted portions 77e. The lock portions 76 are drawn inward in the left-right direction, and the outer ends of the lock portions 76 are disengaged from the lock engagement holes 21k to cancel prevention of movement of the drawer member 3. Thus, the drawer member 3 is advanced by urging force of the urging member 74 of the movable portion 71. When the holder body 31 is pressed rearward, the drawer member 3 is retracted and stored in the storage case 2.

The drawer member 3 has the holder body 31, the bottom member 35, the rear member 42, and the front member 41 as described above. The drawer member 3 will be described in more detail.

As shown in FIG. 3, FIG. 9, and FIG. 12, rear support portions 31g are provided on the side surface portions on both the left and right sides of the base portion 31a on the rear side of the holder body 31. A front support portion 31h is provided on the back surface side of the holder portion 31b on the front side of the holder body 31. In the present embodiment, each rear support portion 31g is a round hole, and the front support portion 31h is a long hole that extends in the advancing and retracting direction. Recesses 35b are formed on both the left and right sides of the bottom member 35, and at the center, in the left-right direction, of the bottom member 35, and round holes are formed as rear support portions 35c in the wall portions that surround both the sides, in the left-right direction, of each recess 35b. A dent 35d is formed at the center portion in the left-right direction of the bottom member 35 so as to be dented gradually deeply from the rear portion toward the front portion, and front support portions 35e are formed at the wall portions on both the left and right sides of the dent 35d. In the present embodiment, the rear support portions 35c and the front support portions 35e of the bottom member 35 are round holes.

The rear member 42 is a rectangular plate-like member that is elongated in the left-right direction. Upper support portions 42a are provided on the upper ends of the side surface portions on both the left and the right sides of the rear member 42. Lower support portions 42b are provided on both the left and right sides and at the center in the left-right direction on the lower end of the rear member 42. The upper support portions 42a of the rear member 42 are supported by the rear support portions 31g of the holder body 31 so as to be rotatable relative to each other. The lower support portions 42b of the rear member 42 are supported by the rear support portions 35c of the bottom member 35 so as to be rotatable relative to each other. Thus, the rear member 42 is supported by the rear support portions 31g of the holder body 31 and the rear support portions 35c of the bottom member 35 so as to be swingable. Springs 43 and 44 are disposed between the upper support portions 42a of the rear member 42 and the rear support portions 31g of the holder body 31, and between lower support portions 41b of the front member 41 and the front support portions 35e of the bottom member 35, respectively.

In the present embodiment, the upper support portions 42a and the lower support portions 42b of the rear member 42 are rotation shafts, and the rear support portions 31g of the holder body 31 and the rear support portions 35c of the bottom member 35 are round holes in which the rotation shafts are rotatably inserted. However, conversely, the upper support portions 42a and the lower support portions 42b of the rear member 42 may be round holes, and the rear support portions 31g of the holder body 31 and the rear support portions 35c of the bottommember 35 may be rotation shafts which can be rotatably inserted in the round holes.

The front member 41 is a rod-shaped member, and upper support portions 41a are provided at the upper end portion thereof, and the lower support portions 41b are provided at the lower end portion of the front member 41. The upper support portions 41a of the front member 41 are supported by the front support portion 31h of the holder body 31 so as to be rotatable relative thereto, and be movable relative thereto in the front-rear direction. The lower support portions 41b of the front member 41 are supported by the front support portions 35e of the bottom member 35 so as to be rotatable relative thereto. Thus, the front member 41 is supported by the front support portion 31h of the holder body 31 and the front support portions 35e of the bottom member 35 so as to be swingable.

Both of the front member 41 and the rear member 42 are supported so as to be swingable relative to the holder body 31 and the bottom member 35. Therefore, the holder body 31, the front member 41, the bottom member 35, and the rear member 42 form a four element linking mechanism.

As shown in FIG. 10, when the drawer member 3 is stored in the storage case 2, the front member 41 and the rear member 42 are oriented almost horizontally, and the holder body 31 and the bottom member 35 are made close to each other. The height, in the up-down direction, of the holder body 31 from the bottom member 35 is less than the width, in the up-down direction, of the opening 23 of the storage case 2.

As shown in FIG. 9, when the drawer member 3 has been drawn from the storage case 2, the bottom member 35 is lowered by urging force of the springs 43, 44, and the front member 41 and the rear member 42 are raised at an angle that almost represents the up-down direction (vertical direction), and the height, in the up-down direction, of the holder body 31 from the bottom member 35 is increased. The height, in the up-down direction, of the holder body 31 from the bottommember 35 is greater than the width, in the up-down direction, of the opening 23.

In the present embodiment, the bottommember 35 and the holder body 31 are connected by the front member 41 and the rear member 42. Therefore, strength of connection between the holder body 31 and the bottom member 35 is enhanced.

As shown in FIG. 9, A represents a distance between the front side portion of the holder body 31 and the front side portion of the bottom member 35, and B represents a distance between the rear side portion of the holder body 31 and the rear side portion of the bottom member 35. The front side portion of the holder body 31 is disposed forward of the rear side portion of the holder body 31. A represents a distance, in the up-down direction, between the front side portion of the holder body 31 and the front side portion of the bottom member 35. B represents a distance, in the up-down direction, between the rear side portion of the holder body 31 and the rear side portion of the bottom member 35.

In this case, when the drawer member 3 is drawn forward, the distance A is preferably greater than the distance B. In a case where the drawer member 3 is drawn forward, when the distance A is greater than the distance B, the height, from the bottom member 35, of the holder portion 31b disposed on the front side of the holder body 31 is increased as compared to when the distance A is equal to the distance B. When a beverage container is positioned at the holder portion 31b and the bottom member 35, force for holding the beverage container by the holder portion 31b and the bottom member 35 is enhanced. Since the holder body 31 is tilted downward in the rear direction, the center of gravity of the entirety of the drawer member 3 is made closer to the rear side and closer to the front side slide engagement portion 86 and the rear side slide engagement portion 87 that serve as support points with respect to the storage case 2, as compared to when the holder body 31 is horizontally oriented. Therefore, moment on the front side slide engagement portion 86 and the rear side slide engagement portion 87 is reduced and the beverage container can be stably held.

As a structure in which the distance A is made greater than the distance B when the drawer member is drawn, the following structure is used in the present embodiment.

In the present embodiment, a distance C between the upper support portion 41a and the lower support portion 41b of the front member 41 is made greater than a distance D between the upper support portion 42a and the lower support portion 42b of the rear member 42. Further, the front support portion 31h of the holder body 31 is a long hole that extends in the advancing and retracting direction. By the long hole forming the front support portion 31h, the rotation shaft that forms the upper support portion 41a of the front member 41 is supported so as to be slidable in the advancing and retracting direction. In the structure of the present embodiment, when the drawer member 3 is drawn to the advance position, the bottom member 35 is lowered by urging force of the springs 43, 44, and the front member 41 is raised to change its orientation from the horizontal orientation to the vertical orientation. Therefore, as shown in FIG. 12, the upper support portion 41a of the front member 41 slides toward the front portion of the long hole that forms the front support portion 31h of the holder body 31 and is positioned at a front end position 31j of the long hole. At this time, the front member 41 is raised at an angle that almost represents the vertical direction, and an angle a of the front member 41 relative to the vertical direction is less than an angle β of the rear member 42 relative to the vertical direction. Further, the distance C between the upper support portion 41a and the lower support portion 41b of the front member 41 is greater than the distance D between the upper support portion 42a and the lower support portions 42b of the rear member 42. Therefore, the distance A between the front support portion 31h of the holder body 31 and the front support portion 35e of the bottom member 35 is greater than the distance B between the rear support portion 31g of the holder body 31 and the rear support portion 35c of the bottom member 35.

Examples of the structure in which the distance A is made greater than the distance B when the drawer member 3 is drawn, may include, in addition to the structure of the present embodiment, a structure in which the distance C between the upper support portion 41a and the lower support portion 41b of the front member 41 is equal to or less than the distance D between the upper support portion 42a and the lower support portion 42b of the rear member 42 (CSD), the front member 41 is raised more vertically when the drawer member 3 is drawn, and the angle a of the front member 41 relative to the vertical direction is made much less than the angle β of the rear member 42 relative to the vertical direction.

Further, when the drawer member 3 is drawn, the front member 41 is approximately horizontally oriented, the angle α of the front member 41 relative to the vertical direction is made equal to or greater than the angle β of the rear member 42 relative to the vertical direction (α≧β) , and the distance C between the upper support portion 41a and the lower support portion 41b of the front member 41 is made much greater than the distance D between the upper support portion 42a and the lower support portion 42b of the rear member 42, whereby the distance A can be made greater than the distance B.

Further, in the present embodiment, as shown in FIG. 9 and FIG. 10, when the holder body 31 is retracted to the retraction position, the lower end of the rear member 42 contacts with the bottom wall 21a of the storage case 2, and the rear member 42 swings around the upper support portions 42a and the lower support portions 42b so as to be horizontally oriented. According to the rear member 42 being close to the horizontal orientation, the bottom member 35 is made close to the holder body 31, and the height of the holder body 31 from the bottom member 35 is reduced. The height of the holder body 31 from the bottom member 35 is made less than the width, in the vertical direction, of the opening 23 of the storage case 2.

As shown in FIG. 9 and FIG. 12, since the distance C between the upper support portion 41a and the lower support portion 41b of the front member 41 is greater than the distance D between the upper support portion 42a and the lower support portion 42b of the rear member 42, the upper support portion 41a of the front member 41 slides rearward in the front support portion 31h of the holder body 31 according to the bottom member 35 being moved upward. The upper support portion 41a is moved relative to the front support portion 31h to a rear end position 31k of the long hole that is the front support portion 31h. The front member 41 is swung so as to be oriented more horizontally than the rear member 42 is. Therefore, the height of the holder body 31 from the bottom member 35 can be reduced over the entirety of the holder body 31 in the advancing and retracting direction. The entirety of the holder body 31 and the bottom member 35 is stored in the storage case 2.

In the present embodiment, the front support portion 31h of the holder body 31 is implemented as a long hole. However, the front support portion 31h may have any structure that allows the front member 41 to be approximately horizontally oriented relative to the rear member 42 when the holder body 31 is retracted in the storage case 2 as compared to when the holder body 31 is advanced to the advance position. For example, both the front support portion 31h of the holder body 31 and the front support portions 35e of the bottom member 35 may be implemented as long holes, or the front support portions 35e of the bottom member 35 may be implemented as long holes instead of the front support portion 31h being implemented as a long hole. Alternatively, both the front support portion 31h of the holder body 31 and the front support portions 35e of the bottom member 35 may be implemented as rotation shafts, and the upper support portion 41a and/or the lower support portion 41b of the front member 41 may be implemented as long holes.

In the present embodiment, a coil spring is used as the urging member 74 of the movable portion 71 . However, a constant force spring may be used. Further, the damper device 75 is used to reduce increase of a rotation speed of the pinion gear 73e. However, the damper device 75 may not be provided. Further, the power source for the movable portion 71 is the urging member 74. However, the power source may be a motor.

In the present embodiment, the orientation changing portion 85 has the upper rail portion 88 and the lower rail portion 89 provided in the storage case 2, and the front side slide engagement portion 86 and the rear side slide engagement portion 87 provided in the drawer member 3. However, the drawer member 3 may have the upper rail portion 88 and the lower rail portion 89, and the storage case 2 may have the front side slide engagement portion 86 and the rear side slide engagement portion 87. Further, the orientation of the drawer member 3 is controlled in two portions which are the front side slide engagement portion 86 and the rear side slide engagement portion 87 on each of the left and right sides. However, the orientation thereof may be controlled by one slide engagement portion.

In the present embodiment, the holder body 31 is advanced from and retracted into the opening 23 of the storage case 2 according to movement of the movable portion 71 in the front-rear direction. When the holder body 31 is retracted to the retraction position in the opening 23 of the storage case 2, the holder body 31 is oriented by the orientation changing portion 85 such that the direction in which the thin-plate-shaped plane of the holder body 31 extends is almost parallel to the advancing and retracting direction, and the orientation thereof is regulated so as to be a predetermined orientation in which the holder body 31 can be stored in the opening 23 of the storage case 2. Therefore, even when the storage case 2 is thin, the holder body 31 can be stored therein. Reduction in thickness of the cup holder device 11 can be achieved.

When the holder body 31 is drawn from the retraction position to the advance position, the orientation of the holder body 31 is changed from the predetermined orientation in which the holder body 31 can be stored at the retraction position, by the orientation changing portion 85, according to movement of the movable portion 71 in the advancing and retracting direction. Therefore, when the holder body 31 is drawn, the holder body 31 is oriented so as to be tilted relative to the advancing and retracting direction. Thus, the holder body 31 is tilted such that the front end portion, of the holder body 31, on the advance side is oriented upward, and the height of the holder body 31 from the bottom member 35 is increased, whereby a beverage container can be stably held.

The drawing linkage portion 81 has: the guide portions 82 that are provided in the gear box 72 of the movable portion 71 and that extend in the up-down direction; and the engagement portions 83 that are provided in the holder body 31 and inserted in the guide portions 82 . When the holder body 31 is displaced by the orientation changing portion 85, the engagement portions 83 are moved in the up-down direction along the guide portions 82. Therefore, the position of the holder body 31 can be changed in the up-down direction relative to the movable portion 71 according to the movement in the front-rear direction. Therefore, the orientation of the holder body 31 can be smoothly changed according to the movement in the front-rear direction without interference with the movable portion 71.

### Second Embodiment

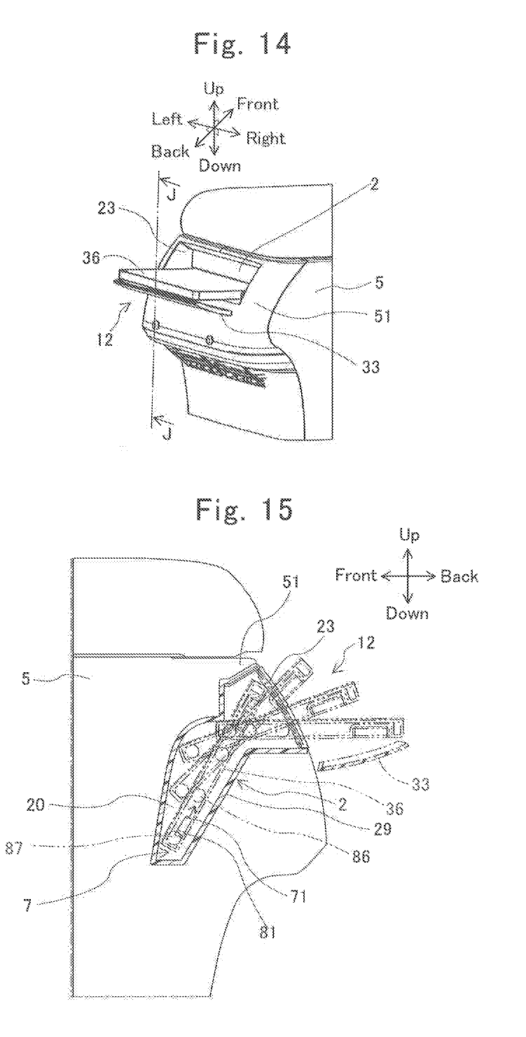

In a second embodiment, as the drawer device of the present invention, a drawable table device is used. As shown in FIG. 14 and FIG. 15, for example, a drawable table device 12 is mounted to a rear surface portion 51 of a center console 5 at the center of front seats in a vehicle interior. The table device 12 includes: a storage case 2 that is provided in the rear surface portion 51 of the center console 5; a table 36 that is a drawer member which is stored in the storage case 2 so as to be advanced and retracted; and an advancing and retracting mechanism 7.

In the storage case 2, a space 20 in which the table 36 can be stored is formed. The space 20 is in communication with the outside through an opening 23 formed in the rear portion of the storage case 2. The opening 23 is covered with a design cover 33 so as to be opened and closed. The design cover 33 is urged by a not-illustrated spring in the direction in which the opening 23 is closed.

The table 36 is a rectangular-thin-plate-shaped. The table 36 can be moved between the retraction position at which the table 36 is stored in the space 20 of the storage case 2, and the advance position to which the table 36 is advanced from the opening 23 . When the table 36 is drawn to the advance position, the table 36 presses the design cover 33 that covers the opening 23, and the design cover 33 is opened against urging force of the not-illustrated spring, and the table 36 is advanced from the opening 23.

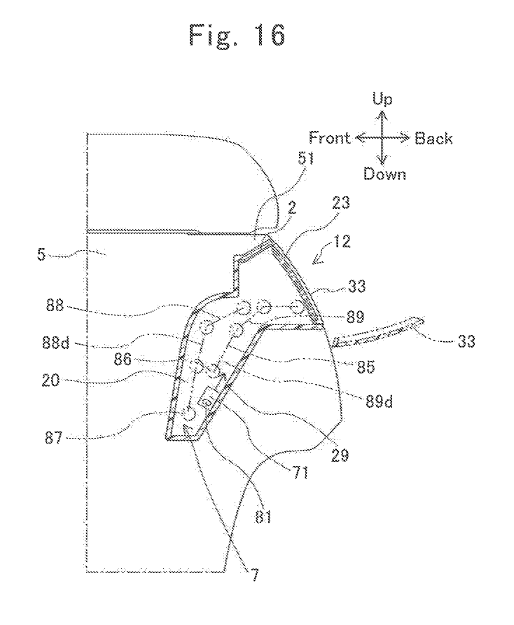

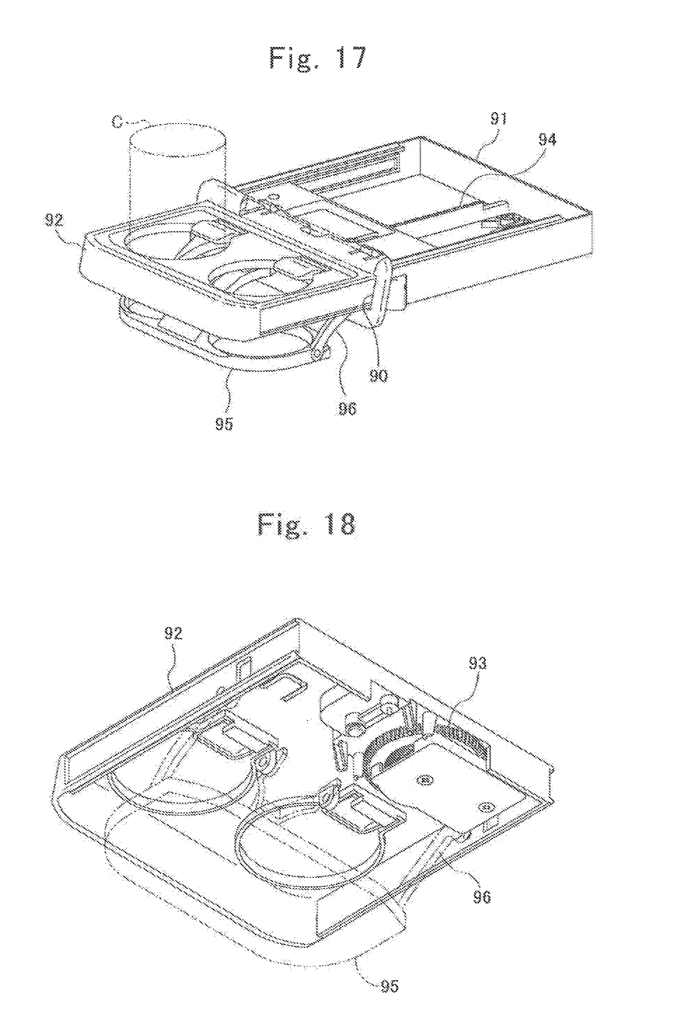

The advancing and retracting mechanism 7 is similar to that of the cup holder device 11 described above. As shown in FIG. 16, the advancing and retracting mechanism 7 of the table device 12 includes a movable portion 71, a drawing linkage portion 81, and an orientation changing portion 85, similarly to that of the cup holder device 11.

A lower wall 29 of the storage case 2 is tilted upward relative to the rear direction of the vehicle, and the movable portion 71 is advanced and retracted along the lower wall. The movable portion 71 is moved in the advancing direction along the lower wall 29 of the storage case 2 by driving force of a drive source such as an urging member or a motor provided inside. The drawing linkage portion 81 is disposed between the movable portion 71 and the table 36. The drawing linkage portion 81 allows the table 36 to be moved in the advancing and retracting direction according to movement of the movable portion 71, and allows the table 36 to be displaced such that the table 36 is oriented almost perpendicular to the advancing and retracting direction (see FIG. 3). The orientation changing portion 85 has an upper rail portion 88 and a lower rail portion 89 provided in the storage case 2, and a front side slide engagement portion 86 and a rear side slide engagement portion 87 provided in the table 36.

In FIG. 16, the upper rail portion 88 and the lower rail portion 89 are represented by the center lines thereof. The upper rail portion 88 has a tilted portion 88d that is tilted relative to the advancing and retracting direction. The lower rail portion 89 has an advance and retraction extension portion 89d that extends along the advancing and retracting direction of the table 36. The rear side slide engagement portion 87 and the front side slide engagement portion 86 slidably engage with the upper rail portion 88 and the lower rail portion 89. Thus, when the table 36 is at the retraction position, the orientation of the table 36 is regulated so as to be a predetermined orientation in which the table 36 can be stored in the storage case 2, and, according to the table 36 advancing from the retraction position, the orientation of the table 36 is changed from the predetermined orientation. When the table 36 is positioned at the advance position, the surface of the table 36 is horizontally oriented.

Also in the second embodiment, similarly to the first embodiment, the table 36 is oriented so as to be titled relative to the advancing and retracting direction when the table 36 is drawn, and the reduction in thickness can be also achieved.

(1) A drawer device (cup holder device 11, table device 12) according to the first and the second embodiments includes: a storage case 2 having an opening 23; a drawer member 3 stored in the storage case 2 so as to be advanced from the opening 23 toward an advance side or retracted into the opening 23 toward a retraction side; and an advancing and retracting mechanism 7 configured to move the drawer member 3 between an advance position to which the drawer member 3 is advanced from the opening 23, and a retraction position to which the drawer member 3 is retracted into the opening 23, and

the advancing and retracting mechanism 7 includes:

a movable portion 71 provided in the storage case 2 and configured to be movable in an advancing and retracting direction;

a drawing linkage portion 81 configured to move the drawer member 3 in the advancing and retracting direction according to movement of the movable portion 71 in the advancing and retracting direction, and to displace the drawer member 3 so as to orient the drawer member 3 almost perpendicular to the advancing and retracting direction, by causing the drawer member 3 and the movable portion 71 to cooperate with each other; and

an orientation changing portion 85 configured to regulate the drawer member 3 so as to be in a predetermined orientation in which the drawer member 3 can be stored in the storage case 2 when the drawer member 3 is at the retraction position, and to displace the drawer member 3 from the predetermined orientation to another orientation when the drawer member 3 is drawn to the advance position according to advancing of the movable portion 71.

In the above-described configuration, the drawer member 3 is advanced from or retracted into the opening 23 of the storage case 2 according to movement of the movable portion 71 in the advancing and retracting direction. When the drawer member 3 is retracted to the retraction position in the opening 23 of the storage case 2, the orientation of the drawer member 3 is regulated by the orientation changing portion 85 so as to be a predetermined orientation in which the drawer member 3 can be stored in the opening 23 of the storage case 2. When the drawer member 3 is drawn to the advance position by advancing of the movable portion 71, the orientation of the drawer member 3 is changed from the predetermined orientation to another orientation by the orientation changing portion 85. For example, the orientation of the drawer member 3 is regulated such that the drawer member 3 at the retraction position has a height less than the width of the opening 23, whereby the drawer member 3 can be stored even in a thin storage case 2. Therefore, the drawer member 3 can be displaced so as to be tilted relative to the advancing and retracting direction when the drawer member 3 is drawn, and reduction in thickness of the drawer device can be also achieved.

In a case where the drawer member 3 and the movable portion 71 are connected such that the drawer member 3 and the movable portion 71 cannot be displaced relative to each other, when the orientation of the drawer member 3 is changed, the drawer member 3 may interfere with the movable portion that is movable in the advancing and retracting direction.

In the present invention, the drawing linkage portion 81 causes the drawer member 3 and the movable member 71 to cooperate with each other such that the drawer member 3 can be displaced so as to be oriented almost perpendicular to the advancing and retracting direction. The drawing linkage portion 81 allows the drawer member 3 to be moved in the advancing and retracting direction according to movement of the movable portion 71 in the advancing and retracting direction, and allows a relative position of the drawer member 3 relative to the movable portion 71 to be changed according to the orientation of the drawer member 3 being changed. Therefore, the orientation of the drawer member 3 can be smoothly changed according to movement in the advancing and retracting direction without interference with the movable portion 71.

As described above, according to the present invention, the drawer device can be provided in which the drawer member 3 can be displaced so as to be tilted relative to the advancing and retracting direction when the drawer member 3 is drawn, and reduction in thickness can be also achieved.

(2) According to the first and the second embodiments, the storage case 2 preferably has a rack gear 21d that extends in the advancing and retracting direction, and the movable portion 71 preferably includes a pinion gear 73e configured to mesh with the rack gear 21d, and an urging member 74 configured to urge the pinion gear 73e so as to move the movable portion 71 toward the advance side in the advancing and retracting direction.

In the above-described configuration, in the movable portion 71, the pinion gear 73e is urged by urging force of the urging member 74. The urged pinion gear 73e is advanced along the rack gear 21d provided in the storage case 2. In such a simple configuration, the movable portion 71 can be assuredly advanced.

(3) According to the first and the second embodiments, the drawing linkage portion 81 preferably includes: a guide portion 82 provided in one of the movable portion 71 and the drawer member 3, the guide portion 82 extending almost perpendicular to the advancing and retracting direction; and an engagement portion 83 provided in the other of the movable portion 71 and the drawer member 3, and configured to move along the guide portion 82.

In the above-described configuration, the drawer member 3 can be moved in the advancing and retracting direction, according to movement of the movable portion 71, in a simple configuration. Further, also when the orientation of the drawer member 3 is changed by the orientation changing portion 85, the drawer member 3 is displaced relative to the movable portion 71 in the non-advancing/retracting direction, whereby interference with the movable portion 71 can be avoided, and the orientation of the drawer member 3 can be smoothly changed.

(4) According to the first and the second embodiments, the orientation changing portion 85 preferably includes: a rail portion (upper rail portion 88, lower rail portion 89) provided in one of the storage case 2 and the drawer member 3, the rail portion (upper rail portion 88, lower rail portion 89) having a tilted portion that is tilted relative to the advancing and retracting direction; and a slide engagement portion (front side slide engagement portion 86, rear side slide engagement portion 87) provided in the other of the storage case 2 and the drawer member 3 and configured to engage with the rail portion (upper rail portion 88, lower rail portion 89) so as to be movable.

In the above-described configuration, the slide engagement portion slides along the rail portion, whereby the orientation of the drawer member 3 can be changed.

(5) According to the first embodiment, the rail portion preferably includes: an upper rail portion 88 provided on an upper side of an inner lateral side surface of the storage case 2; and a lower rail portion 89 provided, below the upper rail portion 88, on the inner lateral side surface of the storage case 2, the slide engagement portion preferably includes: a front side slide engagement portion 86 provided on the advance side of the drawer member 3; and a rear side slide engagement portion 87 provided on the retraction side rearward of the front side slide engagement portion 86 of the drawer member 3, the front side slide engagement portion 86 is preferably engaged with the upper rail portion 88, and the rear side slide engagement portion 87 is preferably engaged with the lower rail portion 89, and a distance between the upper rail portion 88 and the lower rail portion 89 is preferably increased in the storage case 2, toward a side to which the drawer member 3 is drawn.

In the above-described configuration, a portion, on the advance side, of the drawer member 3 can be tilted so as to be positioned higher than a portion thereof on the retraction side according to the drawer member 3 being drawn from the storage case 2.

(6) According to the first and the second embodiments, preferably, the advancing and retracting mechanism 7 further includes: a lock portion 76 configured to prevent movement of the drawer member 3 at the retraction position; and an operation portion 77 configured to cancel prevention, by the lock portion 76, of movement of the drawer member 3.

In the above-described configuration, the lock portion 76 is configured to prevent movement of the drawer member 3 at the retraction position, and further the prevention of the movement of the drawer member 3 can be cancelled by the operation portion 77 being operated.

(7) According to the first embodiment, the lock portion 76 and the operation portion 77 are preferably provided in the drawer member 3, and the lock portion 76 can be preferably advanced into and retracted from a lock engagement hole 21k formed in the storage case 2, and the lock portion 76 is preferably urged, by a lock urging member 78, in a direction in which the lock portion 76 is engaged with the lock engagement hole 21k.

In the above-described configuration, the drawer member 3 can be regulated so as to be stored in the storage case 2 in a simple configuration.

(8) According to the first embodiment, the drawer member 3 preferably includes: a holder body 31 configured to hold a side surface of a beverage container; and a bottom member 35 configured to hold a bottom portion of the beverage container.

In the above-described configuration, the beverage container can be assuredly held by the holder body 31 and the bottom member 35.

(9) According to the first embodiment, the drawer member 3 preferably includes: a rear member 42 supported by a rear support portion 31g of the holder body 31 and a rear support portion 35c of the bottom member 35 so as to be swingable relative to the holder body 31 and the bottom member 35; and a front member 41 supported by: a front support portion 31h positioned on the advance side forward of the rear support portion 31g of the holder body 31; and a front support portion 35e positioned on the advance side forward of the rear support portion 35c of the bottom member 35 so as to be swingable relative to the holder body 31 and the bottom member 35, a height of the holder body 31 from the bottom member 35 is preferably made greater than a width of the opening 23 of the storage case 2 when the drawer member 3 is drawn to the advance position, and a distance between the holder body 31 and the bottom member 35 is preferably made less than a width of the opening 23 by swinging of the front member 41 and the rear member 42 when the drawer member 3 is retracted to the retraction position.

In the above-described configuration, the bottom member 35 and the holder body 31 are connected by the front member 41 and the rear member 42. Therefore, strength of connection between the holder body 31 and the bottom member 35 is enhanced. Further, when the drawer member 3 is stored in the storage case 2, a distance between the holder body 31 and the bottom member 35 is made less than the width of the opening 23. When the drawer member 3 is drawn to the advance position, the height of the holder body 31 from the bottom member 35 can be made greater than the width of the opening 23, and force of holding the beverage container can be enhanced.

(10) According to the first embodiment, when A represents a distance between a front side portion of the holder body 31 and a front side portion of the bottom member 35, and B represents a distance between a rear side portion of the holder body 31 and a rear side portion of the bottom member 35, the front member 41 and the rear member 42 are preferably connected to the holder body 31 and the bottom member 35 such that the distance A is greater than the distance B in a case where the drawer member 3 has been drawn to the advance position.

In the above-described configuration, in a case where the distance A is greater than the distance B, the height, at an advance position, of the holder body 31 fromthe bottommember 35, particularly, the height on the advance side is increased as compared to a case where the distance A is equal to the distance B. Force of holding the beverage container can be further enhanced.

(11) According to the first embodiment, the front member 41 is preferably movable relative to the holder body 31 or the bottom member 35 such that a difference between the distance A and the distance B in the drawer member 3 having been retracted to the retraction position is less than a difference between the distance A and the distance B in the drawer member 3 having been drawn to the advance position.

In the above-described configuration, the height of the drawer member 3 that is stored in the storage case 2 at the retraction position can be made less than the height of the drawer member 3 which is drawn from the storage case 2 and is at the advance position. Therefore, the reduction of thickness of the storage case 2 can be more assuredly achieved.

(12) According to the first embodiment, the front support portion 31h is preferably a long hole formed in the drawer member 3, and the front member 41 is preferably fitted into the long hole so as to be displaced.

In the above-described configuration, the tilt angle of the front member 41 relative to the holder body 31 and the bottom member 35 can be changed. Thus, when the drawer member 3 is drawn from the storage case 2, the front portion of the holder body 31 can be separated from the bottom member 35, and the holder body 31 can be tilted relative to the bottom member 35. When the drawer member 3 is stored in the storage case 2, the front portion of the holder body 31 can be made close to the bottom member 35. The tilt angle of the stored holder body 31 relative to the bottom member 35 can be changed from the tilt angle of the drawn holder body 31 relative to the bottom member 35.

(13) According to the first embodiment, the holder body 31 preferably includes: a holder portion 31b configured to surround an insertion space 31c in which the beverage container C is inserted; a first swing holding portion 32 having a front end that projects toward the insertion space 31c, and having a base end supported by the holder portion 31b so as to be swingable in an up-down direction; and a spring 36 configured to urge the first swing holding portion 32 so as to orient the front end of the first swing holding portion 32 upward such that the front end thereof is above the base end thereof .

In the above-described configuration, at the front end of the first swing holding portion 32, the side surface of the beverage container C inserted in the insertion space 31c is held at a position higher than the holder portion 31b. Therefore, the beverage container C can be stably held. Further, when the drawer member 3 is stored in the storage case 2, the front end of the first swing holding portion 32 contacts with the storage case 2 at the opening and is pressed downward, and the first swing holding portion 32 is displaced so as to be at the same height as the holder portion 31. Therefore, the first swing holding portion 32 does not prevent the holder body 31 from being stored in the storage case 2.

(14) According to the first embodiment, the holder body 31 preferably includes: a holder portion 31b configured to surround an insertion space 31c in which the beverage container C is inserted; a second swing holding portion 38 having a front end that projects toward the insertion space 31c, and having a base end supported by the holder portion 31b so as to be swingable in an inner and outer direction of the insertion space 31c; and a spring 34 configured to urge the second swing holding portion 38 so as to position the front end of the second swing holding portion 38 inward of the base end thereof in the insertion space 31c.

In the above-described configuration, the beverage container C is held by the front end of the second swing holding portion 38. When the beverage container C has any thickness that allows the beverage container C to be inserted into the insertion space 31c, the front end of the second swing holding portion 38 contacts with the side surface of the beverage container C and the beverage container C can be stably held in the insertion space 31c.

(15) According to the second embodiment, the drawer member 3 preferably has a table 36.

In the above-described configuration, the orientation of the table 36 can be changed between when the table 36 is at the retraction position and when the table 36 is at the advance position.

1. A drawer device comprising:
a storage case having an opening;
a drawer member stored in the storage case so as to be advanced from the opening toward an advance side or retracted into the opening toward a retraction side; and
an advancing and retracting mechanism configured to move the drawer member between an advance position to which the drawer member is advanced from the opening, and a retraction position to which the drawer member is retracted into the opening, wherein
the advancing and retracting mechanism includes:
a movable portion provided in the storage case and configured to be movable in an advancing and retracting direction;
a drawing linkage portion configured to move the drawer member in the advancing and retracting direction according to movement of the movable portion in the advancing and retracting direction, and to displace the drawer member so as to orient the drawer member almost perpendicular to the advancing and retracting direction, by causing the drawer member and the movable portion to cooperate with each other; and
an orientation changing portion configured to regulate the drawer member so as to be in a first orientation in which the drawer member can be stored in the storage case when the drawer member is at the retraction position, and to displace the drawer member from the first orientation to a second orientation when the drawer member is drawn to the advance position according to advancing of the movable portion.

2. The drawer device according to claim 1, wherein
the storage case has a rack gear that extends in the advancing and retracting direction, and
the movable portion includes
a pinion gear configured to mesh with the rack gear, and
an urging member configured to urge the pinion gear so as to move the movable portion toward the advance side in the advancing and retracting direction.

3. The drawer device according to claim 1, wherein
the drawing linkage portion includes:
a guide portion provided in one of the movable portion and the drawer member, the guide portion extending almost perpendicular to the advancing and retracting direction; and
an engagement portion provided in the other of the movable portion and the drawer member and configured to move along the guide portion.

4. The drawer device according to claim 1, wherein
the orientation changing portion includes:
a rail portion provided in one of the storage case and the drawer member, the rail portion having a tilted portion that is tilted relative to the advancing and retracting direction; and
a slide engagement portion provided in the other of the storage case and the drawer member and configured to engage with the rail portion so as to be movable.

5. The drawer device according to claim 4, wherein
the rail portion includes:
an upper rail portion provided on an upper side of an inner lateral side surface of the storage case; and
a lower rail portion provided, below the upper rail portion, on the inner lateral side surface of the storage case,
the slide engagement portion includes:
a front side slide engagement portion provided on the advance side of the drawer member; and
a rear side slide engagement portion provided on the retraction side rearward of the front side slide engagement portion of the drawer member,
the front side slide engagement portion is engaged with the upper rail portion, and the rear side slide engagement portion is engaged with the lower rail portion, and
a distance between the upper rail portion and the lower rail portion is increased in the storage case, toward a side to which the drawer member is drawn.

6. The drawer device according to claim 1, wherein
the advancing and retracting mechanism further includes:
a lock portion configured to prevent movement of the drawer member at the retraction position; and
an operation portion configured to cancel prevention, by the lock portion, of movement of the drawer member.

7. The drawer device according to claim 6, wherein
the lock portion and the operation portion are provided in the drawer member, and
the lock portion can be advanced into and retracted from a lock engagement hole formed in the storage case, and the lock portion is urged, by a lock urging member, in a direction in which the lock portion is engaged with the lock engagement hole.

8. The drawer device according to claim 1, wherein
the drawer member includes:
a holder body configured to hold a side surface of a beverage container; and
a bottom member configured to hold a bottom portion of the beverage container.

9. The drawer device according to claim 8, wherein
the drawer member includes:
a rear member supported by a rear support portion of the holder body and a rear support portion of the bottom member so as to be swingable relative to the holder body and the bottom member; and
a front member supported by: a front support portion positioned on the advance side forward of the rear support portion of the holder body; and a front support portion positioned on the advance side forward of the rear support portion of the bottom member so as to be swingable relative to the holder body and the bottom member,
a height of the holder body from the bottom member is made greater than a width of the opening of the storage case when the drawer member is drawn to the advance position, and
a distance between the holder body and the bottom member is made less than a width of the opening by swinging of the front member and the rear member when the drawer member is retracted to the retraction position.

10. The drawer device according to claim 9, wherein
when A represents a distance between a front side portion of the holder body and a front side portion of the bottom member, and B represents a distance between a rear side portion of the holder body and a rear side portion of the bottom member,
the front member and the rear member are connected to the holder body and the bottom member such that the distance A is greater than the distance B in a case where the drawer member has been drawn to the advance position.

11. The drawer device according to claim 10, wherein the front member is movable relative to the holder body or the bottom member such that a difference between the distance A and the distance B in the drawer member having been retracted to the retraction position is less than a difference between the distance A and the distance B in the drawer member having been drawn to the advance position.

12. The drawer device according to claim 11, wherein
the front support portion is a long hole formed in the drawer member, and
the front member is fitted into the long hole so as to be displaced.

13. The drawer device according to claim 8, wherein
the holder body includes:
a holder portion configured to surround an insertion space in which the beverage container is inserted;
a first swing holding portion having a front end that projects toward the insertion space, and having a base end supported by the holder portion so as to be swingable in an up-down direction; and
a spring configured to urge the first swing holding portion so as to orient the front end of the first swing holding portion upward such that the front end thereof is above the base end thereof.

14. The drawer device according to claim 8, wherein
the holder body includes:
a holder portion configured to surround an insertion space in which the beverage container is inserted;
a second swing holding portion having a front end that projects toward the insertion space, and having a base end supported by the holder portion so as to be swingable in an inner and outer direction of the insertion space; and
a spring configured to urge the second swing holding portion so as to position the front end of the second swing holding portion inward of the base end thereof in the insertion space.

15. The drawer device according to claim 1, wherein the drawer member has a table.
